(19) United States
(12) Patent Application Publication
(10) Pub. No.: US 2021/0279524 A1
(43) Pub. Date: Sep. 9, 2021

(54) TRAINING MODEL CREATION SYSTEM AND TRAINING MODEL CREATION METHOD

(71) Applicant: Hitachi, Ltd., Tokyo (JP)

(72) Inventors: Shimei KO, Tokyo (JP); Kazuaki TOKUNAGA, Tokyo (JP); Toshiyuki UKAI, Tokyo (JP)

(21) Appl. No.: 17/015,585

(22) Filed: Sep. 9, 2020

(30) Foreign Application Priority Data
Mar. 4, 2020 (JP) 2020-036745

(51) Int. Cl. G06K 9/62; G06N 3/08; H04L 29/08

(52) U.S. Cl. CPC G06K 9/6262; G06K 9/6232; H04L 67/10; G06N 3/08; G06K 9/629

(57) ABSTRACT

A training model creation system includes a first server (a mother server 100) that diagnoses a state of an inspection target in a first base (a mother base) using a first model (a mother model) of a neural network and a plurality of second servers (child servers 200) that diagnose a state of an inspection target in each base of the plurality of second bases using a second model (a child model) of the neural network. In the training model creation system, the first server receives feature values of the trained second model from the respective plurality of second servers, merges a received plurality of feature values of the second model and a feature value of the trained first model, and reconstructs and trains the first model based on a merged feature value.

### CROSS-REFERENCE TO RELATED APPLICATION

The present application claims priority from Japanese application JP 2020-036745, filed on Mar. 4, 2020, the contents of which is hereby incorporated by reference into this application.

### BACKGROUND OF THE INVENTION

### Field of the Invention

The present invention relates to a training model creation system and a training model creation method and is suitably applied to a training model creation system and a training model creation method for creating a model of a neural network used to inspect a process carried out in a base.

### Description of the Related Art

In a production process (for example, an assembly process) for industrial products, it has been likely that a defective product (an abnormality) occurs because of an initial failure or assembly work of components (for example, a compressor and a motor). When improvement of product quality, expenses for recovery by reworking, and the like are considered for the abnormality occurrence in the production process, it is desired that, for example, an abnormality can be detected for each process inspection at an early stage of the production process. There has been known a technique for using a neural network for such a process inspection.

For example, Japanese Patent Laid-Open No. 2006-163517 (Patent Literature 1) discloses an abnormality detecting apparatus that attempts to perform abnormality detection with less wrong information by updating a model of a neural network at any time according to a change in a state itself of a monitoring target. The abnormality detecting apparatus disclosed by Patent Literature 1 adds, as an intermediate layer of the neural network, an input vector by data detected in the monitoring target, updates the model, and diagnoses the state of the monitoring target using the updated model.

Incidentally, in recent years, according to globalization of production bases, a form in which a mother factory (Mother Fab) functioning as a model factory is arranged in a home country base and child factories (Child Fabs) functioning as mass production factories are arranged mainly in overseas bases. When attempting to perform an inspection of defective products or the like using a neural network in such globally expanded production bases, it is necessary to quickly technically transfer, from the Mother Fab to the Child Fabs, information such as knowhow for suppressing occurrence of defective products and inspection conditions in a process inspection (or a model constructed based on these kinds of information). Further, in order to construct a common model effective in the bases, it is important not only to expand the information from the Mother Fab to the Child Fabs but also cooperate among a plurality of bases to, for example, feedback information from the Child Fabs to the Mother Fab and share the information among the Child Fabs.

However, when it is attempted to construct the common model adapted to the plurality of bases as explained above, problems described below occur if the technique disclosed in Patent Literature 1 is used.

First, in Patent Literature 1, since the neural network having the network structure including one intermediate layer is used, the input vector by the data detected in the monitoring target can be easily replaced as the intermediate layer during the model update. However, an application method in the case of a neural network including a plurality of intermediate layers is unclear. In Patent Literature 1, since the intermediate layer is simply replaced with new data during the model update, it is likely that a feature value of pervious data is not considered and a model training effect is limited.

In Patent Literature 1, a case in which a plurality of bases use a model is not considered. Even if a model updated using data detected in one base is expanded to the plurality of bases, the model less easily becomes a common model adapted to the plurality of bases. In general, surrounding environments, machining conditions, and the like are different in the respective bases. A model constructed based on only information concerning one base is unlikely to be accepted as a preferred model in the other bases. That is, in order to construct a common model adapted to the plurality of bases, it is necessary to construct, in view of feature values in the bases, a robust common model that can withstand the surrounding environments, the machining conditions, and the like of the bases. Patent Literature 1 does not disclose a model construction method based on such a viewpoint.

### SUMMARY OF THE INVENTION

The present invention has been devised considering the above points and proposes a training model creation system and a training model creation method capable of constructing, in an environment in which a process carried out in a plurality of bases is inspected using a neural network, a robust common model adapted to the bases.

In order to solve such a problem, the present invention provides the following training model creation system that inspects, with a neural network, a process carried out in a plurality of bases including a first base and a plurality of second bases. The training model creation system includes: a first server that diagnoses a state of an inspection target in the first base using a first model of the neural network; and a plurality of second servers that diagnose a state of an inspection target in each base of the plurality of second bases using a second model of the neural network. The first server receives feature values of the trained second model from the respective plurality of second servers, merges a received plurality of feature values of the second model and a feature value of the trained first model, and reconstructs and trains the first model based on a merged feature value.

In order to solve such a problem, the present invention provides the following training model creation method as a training model creation method by a system that inspects, with a neural network, a process carried out in a plurality of bases including a first base and a plurality of second bases. The system includes: a first server that diagnoses a state of an inspection target in the first base using a first model of the neural network; and a plurality of second servers that diagnose a state of an inspection target in each base of the plurality of second bases using a second model of the neural network. The training model creation method includes: a feature value receiving step in which the first server receives feature values of the trained second model from the respective plurality of second servers; a feature value merging step in which the first server merges a plurality of feature values of the second model received in the feature value receiving step and a feature value of the trained first model; and a common model creating step in which the first server reconstructs and trains the first model based on the feature value merged in the feature value merging step.

According to the present invention, it is possible to construct, in an environment in which a process carried out in a plurality of bases is inspected using a neural network, a robust common model adapted to the bases.

### BRIEF DESCRIPTION OF THE DRAWINGS

FIG. 1 is a diagram showing relationship among production bases to which a training model creation system according to this embodiment is applied;

FIG. 2 is a block diagram showing a schematic configuration example of the training model creation system;

FIG. 3 is a block diagram showing a hardware configuration example of a mother server;

FIG. 4 is a block diagram showing a hardware configuration example of a child server;

FIG. 5 is a block diagram showing a functional configuration example of the mother server;

FIG. 6 is a block diagram showing a functional configuration example of the child server;

FIG. 7 is a diagram showing an example of a mother model management table;

FIG. 8 is a diagram showing an example of a child model management table;

FIG. 9 is a diagram showing an example of a feature value management table;

FIG. 10 is a diagram showing an example of a model operation management table;

FIG. 11 is a diagram showing an example of a teacher data management table;

FIG. 12 is a flowchart showing a processing procedure example by the training model creation system at the time when an initial model is mainly constructed;

FIG. 13 is a flowchart showing a processing procedure example by the training model creation system after a feature value and data are shared from the child server;

FIG. 14 is a diagram for explaining an example of a specific method from extraction of a feature value to model retraining; and

FIG. 15 is a diagram for explaining another example of the specific method from the extraction of the feature value to the model retraining.

### DETAILED DESCRIPTION OF THE PREFERRED EMBODIMENT

An embodiment of the present invention is explained in detail below with reference to the drawings.

### (1) Configuration

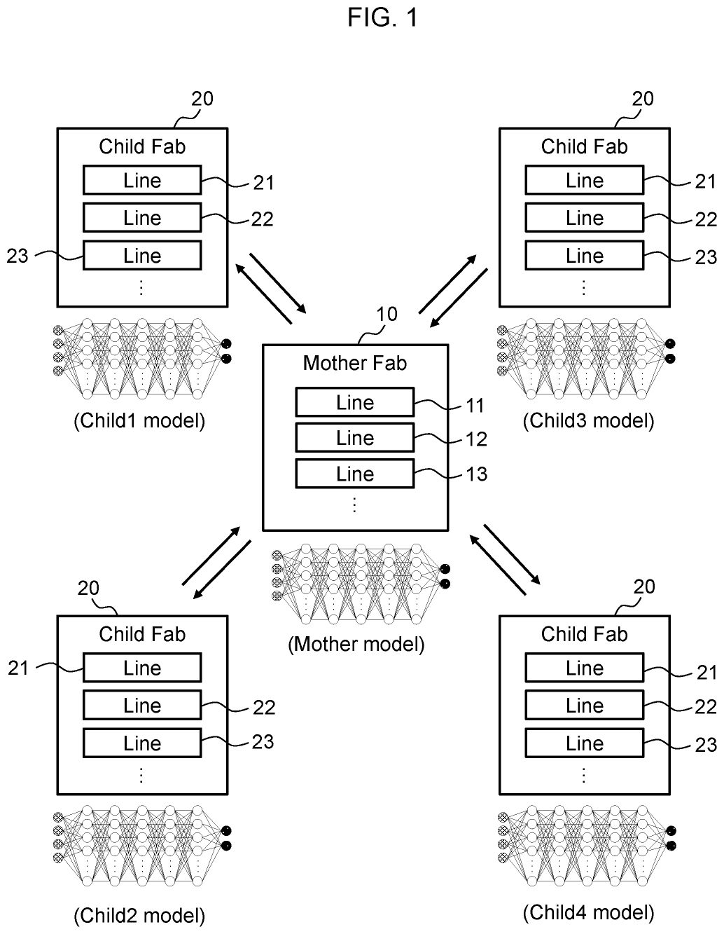

FIG. 1 is a diagram showing relationship among production bases to which a training model creation system according to this embodiment is applied. In FIG. 1, as an example of an environment to which a training model creation system. 1 according to this embodiment is applicable, an image of production bases expanded to a plurality of bases in order to perform a production process such as an assembly process for an industrial product is shown. One mother factory (Mother Fab) 10 and four child factories (Child Fabs) 20 are shown.

The mother factory 10 is a production base constructed in, for example, a home country as a model factory. Specifically, a base where researches and developments for mass production are performed, a base where production is performed at an initial stage, abase where latest equipment is introduced and knowhow of production is established, abase where core components or the like are produced, or the like corresponds to the mother factory 10.

The child factories 20 are production bases constructed, for example, overseas as mass production factories. Note that the mother factory 10 and the child factories 20 are common in that the mother factory 10 and the child factories 20 are production bases concerning the same industrial product. However, production processes carried out in the bases (for example, components to be assembled), manufacturing environments (for example, machines to be used), and the like may be different.

As shown in FIG. 1, the mother factory 10 has a central role and not only collects information from a plurality of child factories 20 but also expands information to the plurality of child factories 20 and gives instructions to the plurality of child factories 20. In principle, exchange of information is not directly performed among the child factories 20. In this embodiment, such a hierarchical relation is represented using words “Mother” and “Child”.

For example, “Mother model” shown in FIG. 1 represents a model of a neural network in a server (a mother server 100) disposed in a base on a Mother side. “Child(n) model” represents a model of a neural network in a server (a child server 200) disposed in a base on a Child side. Note that “Child(n)” is an expression corresponding to an individual Child. When there are four child factories 20 as shown in FIG. 1, “Child(n)” is allocated as, for example, “Child1” to “Child4”.

In the training model creation system 1 according to this embodiment expanded to the plurality of bases, the factories (the mother factory 10 and the child factories 20) can be respectively applied as one base. Besides, production lines provided in the factories can also be set as units of bases. Specifically, in FIG. 1, three production lines (lines 11 to 13) are shown in the mother factory 10 and three production lines (lines 21 to 23) are shown in the child factories 20. For example, when production processes to be carried out, manufacturing environments, line completion periods, and the like are different, the lines can be represented as different production lines. At this time, the lines 11 to 13 and 21 to 23 may be considered as being respectively equivalent to one base. The factories and the lines may be combined with the units of the bases. For example, the mother factory 10 may be set as one base and the lines 21 to 23 of the child factories 20 may be set as different bases.

Further, as at the time when the factories are set as the units of the bases, a relation of Mother-Child also holds among the plurality of bases when the lines are set as the units of the bases. For example, when, among the lines 11 to 13 provided in the mother factory 10, the line 11 is a production line set first and the remaining lines 12 and 13 are production lines added after a production process is established by the line 11, the line 11 is on the Mother side and the lines 12 and 13 are on the Child side. Note that all the lines 21 to 23 in the child factories 20 are on the Child side.

In this way, in this embodiment, the factories or the lines in the factories can be set as the units of the bases. The relation of Mother-Child holds among the plurality of bases. In the following explanation, a base on the Mother side is referred to as mother base and a base on the Child side is referred to as child base.

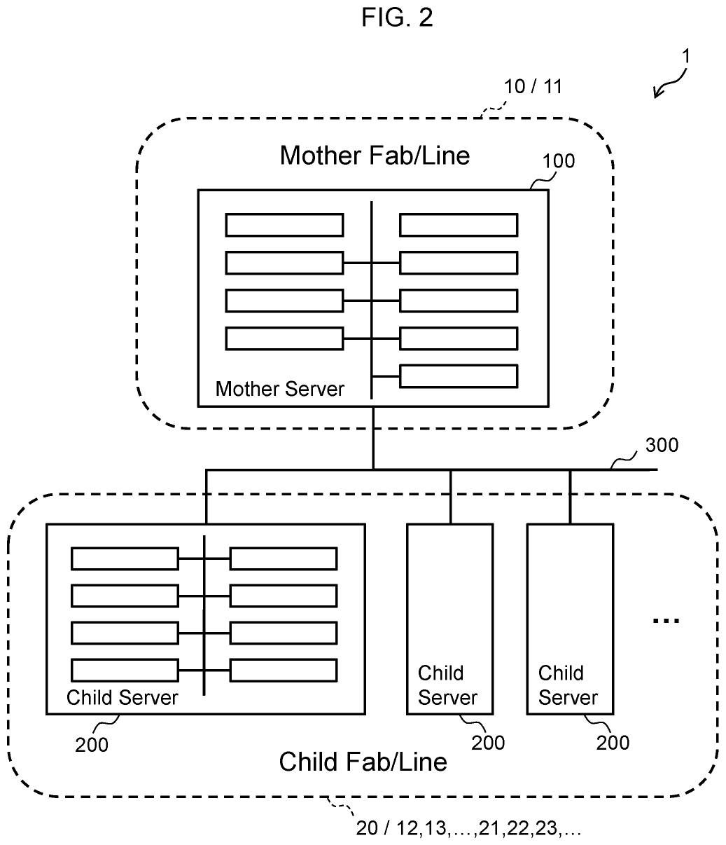

FIG. 2 is a block diagram showing a schematic configuration example of the training model creation system. In FIG. 2, a configuration example of the training model creation system 1 in the case in which one server is disposed in each base is shown.

In FIG. 2, the training model creation system 1 includes the mother server 100 disposed in the mother base and the child servers 200 respectively disposed in a plurality of child bases. The servers are communicably connected via the network 300. At least the mother server 100 and the child servers 200 only have to be communicable. Communication among the child servers 200 may be limited. As explained in detail below, the servers in the bases included in the training model creation system 1 can respectively perform abnormality detection in production processes of the own bases using a neural network. Specifically, in a process inspection in the production processes, a model of the neural network inputs inspection data acquired mainly from an inspection target in the own bases and outputs an abnormality degree to thereby diagnose a state of the inspection target.

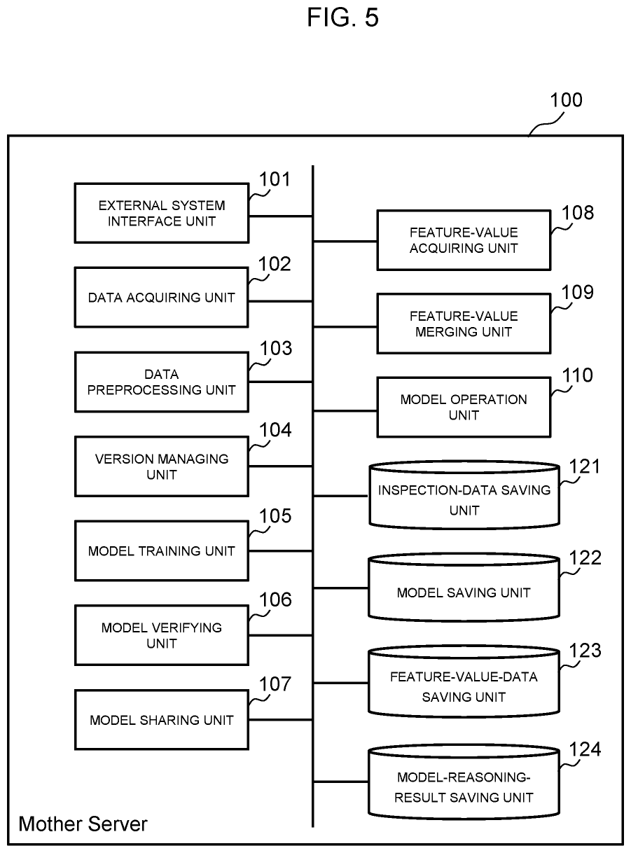

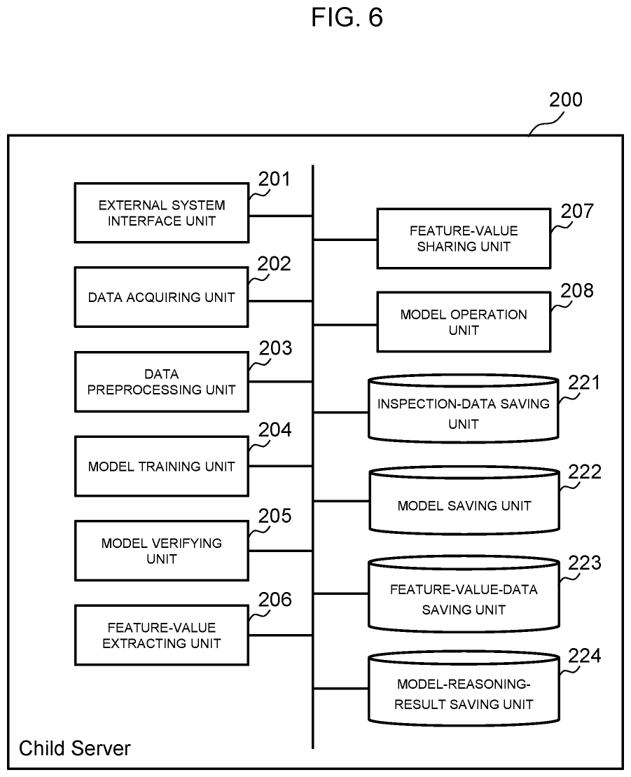

Note that, in FIG. 2, the configuration in the case in which one server is disposed in each base is shown. However, the configuration of the servers included in the training model creation system 1 is not limited to this. The configuration may be a configuration in which, concerning at least a part of the plurality of bases, two or more bases may be operated by one server. Specifically, for example, when the production lines are set as the units of the bases, in the mother factory 10, the line 11, which is the mother base, and the lines 12 and 13, which are the child bases, may be operated by one server. However, when the mother base is included in an operation target of the server, a function equivalent to the mother server 100 is necessary. The training model creation system 1 may use, in the mother base and the child base, a server having both of a function of the mother server 100 (see FIG. 5) and a function of the child servers 200 (see FIG. 6) rather than properly using a disposed server according to whether the base is the mother base or the child base. Note that, for convenience, in the following explanation, the configuration shown in FIG. 2 is used.

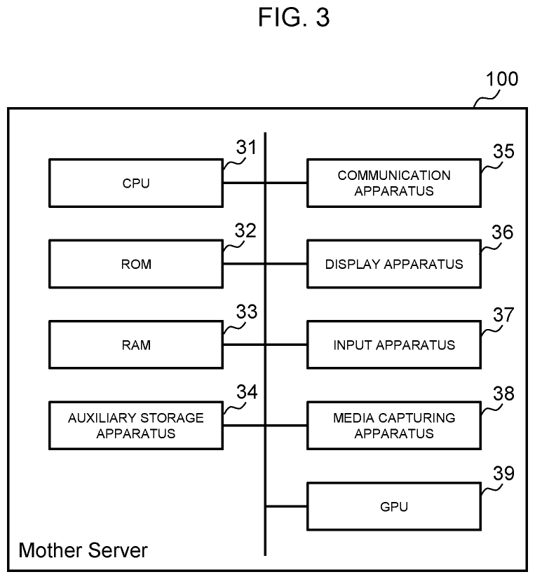

FIG. 3 is a block diagram showing a hardware configuration example of the mother server. The mother server 100 is a GPU server capable of executing training using a neural network. As shown in FIG. 3, the mother server 100 includes, for example, a CPU (Central Processing Unit) 31, a ROM (Read Only Memory) 32, a RAM (Random Access Memory) 33, an auxiliary storage apparatus 34, a communication apparatus 35, a display apparatus 36, an input apparatus 37, a media capturing apparatus 38, and a GPU (Graphics Processing Unit) 39. The components are generally widely-known devices. Therefore, detailed explanation of the components is omitted.

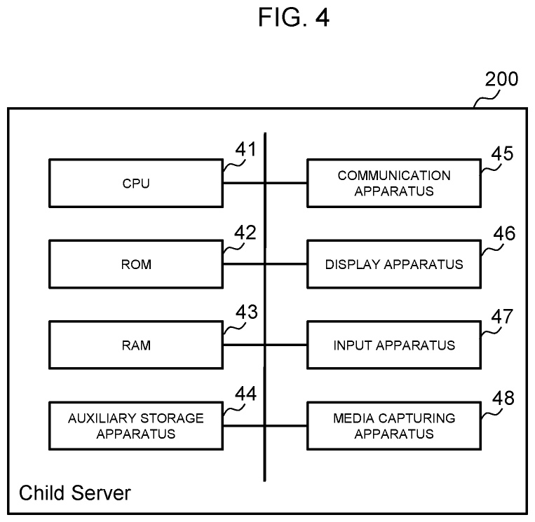

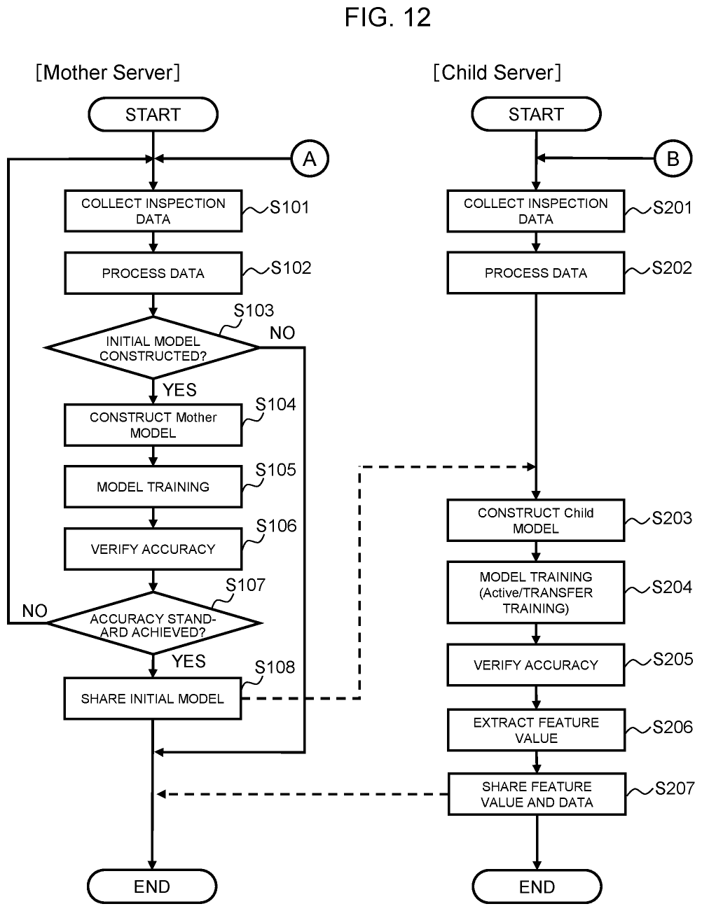

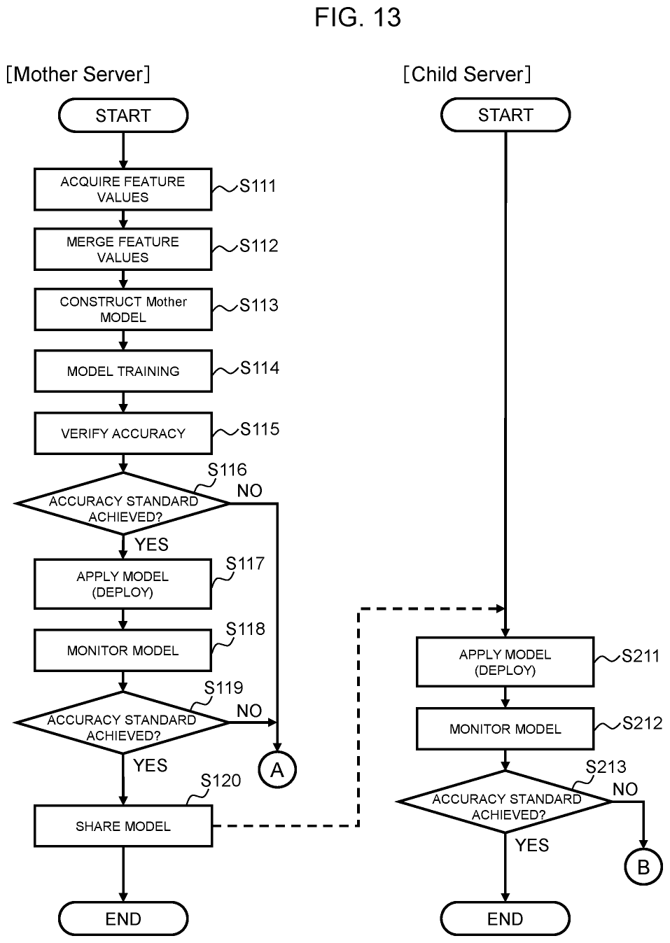

Note that a hardware configuration of the mother server 100 shown in FIG. 3 is different from a hardware configuration of the child server 200 explained below in that the mother server 100 includes the GPU 39 (see FIG. 4). The GPU 39 is a processor having arithmetic operation performance higher than that of the CPU 31. The GPU 39 is used during execution of predetermined processing requiring large-scale parallel calculation such as merging of feature values (step S112 in FIG. 13) and training of a mother model (step S105 in FIG. 12 and step S114 in FIG. 13).

FIG. 4 is a block diagram showing a hardware configuration example of the child server. The child server 200 is a general-purpose server (or may be a GPU server) capable of executing training using a neural network. As shown in FIG. 4, the child server 200 includes, for example, a CPU 41, a ROM 42, a RAM 43, an auxiliary storage apparatus 44, a communication apparatus 45, a display apparatus 46, an input apparatus 47, and a media capturing apparatus 48. The components are generally widely-known devices. Therefore, detailed explanation of the components is omitted.

FIG. 5 is a block diagram showing a functional configuration example of the mother server. As shown in FIG. 5, the mother server 100 includes an external system interface unit 101, a data acquiring unit 102, a data preprocessing unit 103, a version managing unit 104, a model training unit 105, a model verifying unit 106, a model sharing unit 107, a feature-value acquiring unit 108, a feature-value merging unit 109, a model operation unit 110, an inspection-data saving unit 121, a model saving unit 122, a feature-value-data saving unit 123, and a model-reasoning-result saving unit 124.

Among these units, the external system interface unit 101 is realized by the communication apparatus 35 or the media capturing apparatus 38 shown in FIG. 3. The functional units 121 to 124 having a data saving function are realized by the RAM 33 or the auxiliary storage apparatus 34 shown in FIG. 3. The other functional units 102 to 110 are realized by, for example, the CPU 31 (or the GPU 39) shown in FIG. 3 executing predetermined program processing. More specifically, the CPU 31 (or the GPU 39) reads out a program stored in the ROM 32 or the auxiliary storage apparatus 34 to the RAM 33 and executes the program, whereby the predetermined program processing is executed while referring to a memory, an interface, and the like as appropriate.

The external system interface unit 101 has a function for connection to an external system (for example, the child server 200 or a monitoring system for a production process). When the other functional units of the mother server 100 transmit and receive data to and from an external system, the external system interface unit 101 performs an auxiliary function for connection to the system. However, for simplification, in the following explanation, the description of the external system interface unit 101 is omitted.

The data acquiring unit 102 has a function of acquiring, in process inspections, inspection data of types designated in the process inspections. The process inspections are set to be carried out in a predetermined period of a production process in order to detect, for example, occurrence of a defective product in an inspection target early. It can be designated in advance for each of the process inspections what kind of inspection data is acquired.

The data preprocessing unit 103 has a function of performing predetermined processing on the inspection data acquired by the data acquiring unit 102. For example, when inspection data measured in a process inspection is acoustic data (waveform data), for example, processing for executing processing for converting waveform data into an image (for example, Fast Fourier Transform (FFT)) and converting the acoustic data into a spectrum image is equivalent to the processing.

The version managing unit 104 has a function of managing a version of a model of a neural network. In relation to the version management by the version managing unit 104, information concerning the mother model is saved in the model saving unit 122 as a mother model management table 310 and information concerning the child models is saved in the model saving unit 122 as a child model management table 320.

The model training unit 105 has a function of performing, concerning the mother model used in the neural network of the mother server 100, model construction and model training of the neural network.

The model construction of the mother model by the model training unit 105 is processing for dividing collected data into a training dataset for training (or a training dataset for training) and a verification dataset for evaluation and constructing a deep neural network model based on the training dataset. More specifically explained, the model construction is configured from the following processing steps.

First, a neural network structure (a network structure) of the model is designed. At this time, the neural network structure is designed by combining a convolution layer, a pooling layer, a Recurrent layer, an activation function layer, a total integration layer, a Merge layer, a Normalization layer (Batch Normalization or the like), and the like as most appropriate according to a data state.

Subsequently, selection and design of a loss function of the model are performed. The loss function is a function for calculating an error between measurement data (true data) and a model predicted value (predict data). Examples of candidates of the selection include category cross entropy and binary cross entropy.

Subsequently, selection and design of an optimization method for the model are performed. The optimization method for the model is a method of finding a parameter (weight) of training data (or training data) for minimizing the loss function when the neural network performs training. Examples of candidates of the selection include Stochastic Gradient Descent (SGD) such as minibatch stochastic gradient descent, RMSprop, and Adam.

Subsequently, hyper parameters of the model are determined. At this time, parameters (for example, a training ratio and training ratio attenuation of the SGD) used in the optimization method are determined. In order to suppress overtraining of the model, parameters (for example, a minimum number of epoch of a training early end method and a dropout rate of a Dropout method) of a predetermined algorithm are determined.

Finally, selection and design of a model evaluation function are performed. The model evaluation function is a function used to evaluate performance of the model. A function for calculating accuracy is often selected.

The model training of the mother model by the model training unit 105 is performed under an environment of the CPU server (the mother server 100) including the GPU 39 and is processing for actually performing the model training using calculation resources of the GPU 39 based on the network structure, the loss function, the optimization method, the hyper parameters, and the like determined at the stage of the model construction. A mother model (a trained model) after the end of the model training is saved in the model saving unit 122.

The model verifying unit 106 has a function of performing accuracy verification for the trained model of the mother model and a function of performing accuracy verification for a reasoning result by the mother model being operated.

When performing the accuracy verification for the trained model of the mother model, the model verifying unit 106 reads, based on the model evaluation function determined at the stage of the model construction, the trained model saved in the model saving unit 122, calculates an inference result (a reasoning result) in the trained model using the verification dataset as input data, and outputs verification accuracy of the trained model. For example, teacher data can be used as the verification dataset. Further, the model verifying unit 106 compares the output verification accuracy with a predetermined accuracy standard (an accuracy standard for model adoption) determined beforehand to thereby determine possibility of adoption of the trained model (the mother model). Note that the reasoning result calculated in the process of the accuracy verification is saved in the model-reasoning-result saving unit 124. The verification dataset used for the accuracy verification and the verification accuracy (a correct answer ratio) output in the accuracy verification are registered in the mother model management table 310.

On the other hand, the accuracy verification of the reasoning result by the mother model being operated is processing executed at a predetermined timing after the mother model is deployed in a full-scale operation environment of the mother base (the mother server 100). The accuracy verification determines whether the model being operated satisfies a predetermined accuracy standard (an accuracy standard for model operation) for enabling the model to operate. Details of the accuracy verification are explained in processing in step S119 in FIG. 13.

The model sharing unit 107 has a function of sharing the mother model with the child servers 200. When sharing the mother model, the model sharing unit 107 transmits design information (for example, a network structure and a feature value) of the shared model to the child servers 200.

The feature-value acquiring unit 108 has a function of acquiring a feature value and data (a small sample) of a child model received from the child server 200. As explained in detail below, the small sample is data of characteristic information of a child base partially extracted from inspection data collected in the child servers 200. When the small sample is shared with the mother server 100 together with a feature value of the trained child model by the feature-value sharing unit 207, the feature-value acquiring unit 108 acquires the small sample. The feature-value acquiring unit 108 also has a function of acquiring a feature value of a mother model in the mother server 100. The feature value and the data acquired by the feature-value acquiring unit 108 are saved in the feature-value-data saving unit 123.

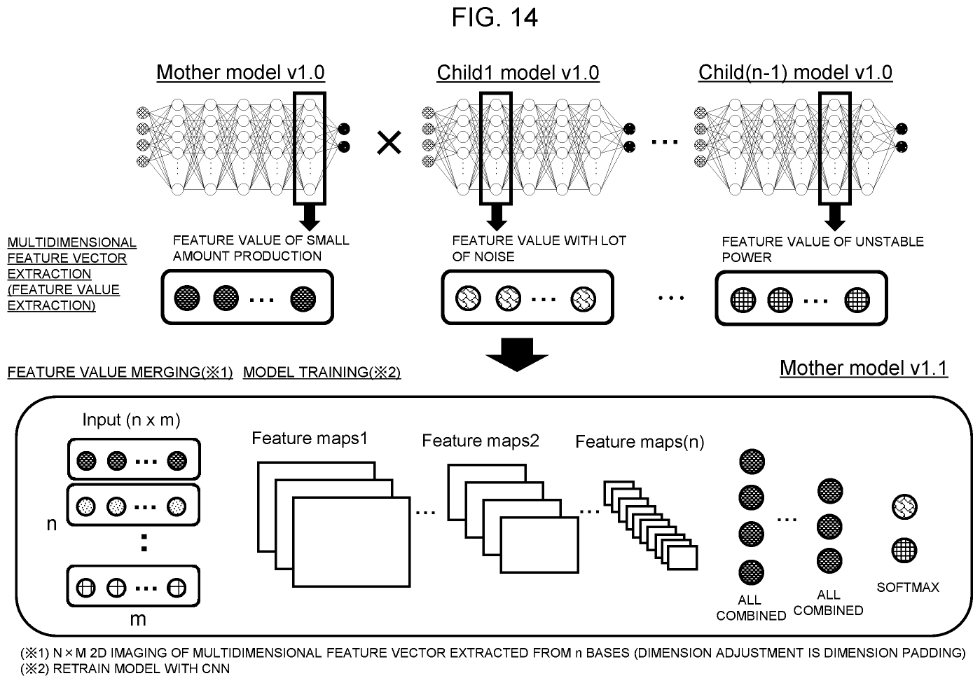

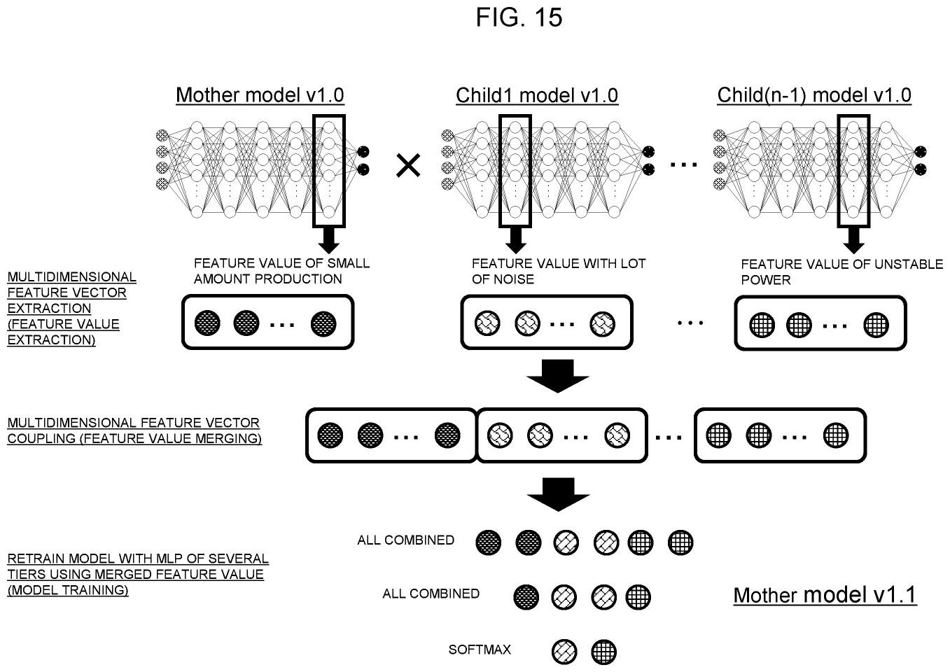

The feature-value merging unit 109 has a function of merging feature values of models saved in the feature-value-data saving unit 123. A specific method example of the feature value merging by the feature-value merging unit 109 is explained in detail below with reference to FIGS. 14 and 15. A feature value merged by the feature-value merging unit 109 (a merged feature value) is saved in the feature-value-data saving unit 123.

The model operation unit 110 has a function of operating a predetermined trained model in the full-scale operation environment of the mother base (the mother server 100). Specifically, when a mother model constructed by capturing the merged feature value merged by the feature-value merging unit 109 achieves the standard accuracy for the model adoption, the model operation unit 110 deploys the model in the full-scale operation environment (a production process) of the mother server 100, performs reasoning (identification) from input data using the model during operation, and performs monitoring on a result of the reasoning.

The inspection-data saving unit 121 saves the inspection data acquired by the data acquiring unit 102 or the inspection data after being subjected to the processing by the data preprocessing unit 103.

Besides saving the mother mode litself, the model saving unit 122 saves the mother model management table 310, the child modelmanagementtable320,amodeloperationmanagementtable 340, and a teacher data management table 350.

The feature-value-data saving unit 123 saves feature values of the mother model and the child models and data (small samples) extracted from inspection data of the child bases. The feature-value-data saving unit 123 saves a feature value management table 330 for managing a merged feature value obtained by merging the feature values of the mother model and the child models and correspondence between the merged feature value and the mother model capturing the merged feature value.

The model-reasoning-result saving unit 124 saves the reasoning result by the mother model.

Note that the functional units 101 to 124 shown in FIG. 5 are classified according to the functions and not always need to be realized by independent modules. A plurality of functional units may be integrated.

FIG. 6 is a block diagram showing a functional configuration example of the child server. As shown in FIG. 6, the child server 200 includes an external system interface unit 201, a data acquiring unit 202, a data preprocessing unit 203, a model training unit 204, a model verifying unit 205, a feature-value extracting unit 206, a feature-value sharing unit 207, a model operation unit 208, an inspection-data saving unit 221, a model saving unit 222, a feature-value-data saving unit 223, and a model-reasoning-result saving unit 224.

Among these units, the external system interface unit 201 is realized by the communication apparatus 45 or the media capturing apparatus 48 shown in FIG. 4. The functional units 221 to 224 having a function of saving data are realized by the RAM 43 or the auxiliary storage apparatus 44 shown in FIG. 4. The other functional units 202 to 224 are realized by, for example, the CPU 41 shown in FIG. 4 executing predetermined program processing. More specifically, the CPU 41 reads out a program stored in the ROM 42 or the auxiliary storage apparatus 44 to the RAM 43 and executes the program, whereby the predetermined program processing is executed while referring to a memory, an interface, and the like as appropriate.

The functional units 201 to 224 of the child server 200 are explained below. However, concerning functional units having the same functions as the functional units having the same names as the functional units of the mother server 100 (including functional units having the word “ child” instead of the word “mother”), repeated explanation is omitted.

The model training unit 204 has a function of performing model construction and model training concerning a child model used in a neural network of the child server 200.

In the model construction of the child model by the model training unit 204, the child model is constructed in the same network structure as the network structure of the mother model based on design information of the mother model shared from the mother server 100. However, for accuracy improvement, it is preferable that tuning corresponding to the child base is performed on hyper parameters (for example, a training rate and the number of times of training). Details of the other model construction may be considered the same as the processing of the model training unit 105 by the mother server 100.

The model training of the child model by the model training unit 204 is processing for performing active training, transfer training, and the like using calculation resources of the CPU 41 based on the network structure, the loss function, the optimization method, the hyper parameters, and the like determined at the stage of the model construction. The child model (a trained model) after the end of the model training is saved in the model saving unit 222.

The model verifying unit 205 has a function of performing accuracy verification of the trained model of the child model and a function of performing accuracy verification of a reasoning result by a child model being operated. Processing for performing the accuracy verification of the trained model of the child model is the same as the processing of the model verifying unit 106 for performing the accuracy verification of the trained model of the mother model. On the other hand, the accuracy verification of the reasoning result by the child model being operated is processing executed at a predetermined timing after the mother model shared from the mother server 100 is deployed in a full-scale operation environment of the child base (the child server 200). The accuracy verification determines whether a predetermined accuracy standard (an accuracy standard of model operation) for enabling the model being operated (the shared mother model) to operate is satisfied. Details of the accuracy verification are explained below in processing in step S213 in FIG. 13.

The feature-value extracting unit 206 has a function of extracting a feature value of the child model and a function of extracting, out of inspection data collected in a child base, characteristic data (small sample) of the child base. The feature value and the data (the small sample) extracted by the feature-value extracting unit 206 are saved in the feature-value-data saving unit 223.

In this embodiment, a feature value of a model is information representing a characteristic of a base or a process in which the model is operated and can be represented by combining weights (coefficients) of tiers configuring a neural network. For example, when a feature value of a certain model is extracted, in a tier structure of a plurality of layers in the model, tiers representing characteristics of a base where the model is operated are selected. A feature value of the model is extracted by a matrix (a vector) obtained by combining weights of the selected tiers. Since the feature value can be evaluated using teacher data, for example, the feature-value extracting unit 206 extracts, as a feature value of the child model, a feature value with which a best evaluation result is obtained (a feature value best representing a characteristic of the child base).

Note that a specific method of extracting a feature value of a model, for example, a gradient method called Grad-CAM (Gradient-weighted Class Activation Mapping) for visually explaining a prediction result of a convolutional neural network (CNN) can be used. When the Grad-CAM is used, it is possible to emphasize, with a heat map, a characteristic part from a degree of importance of influence on prediction and specify a feature value of a tier including specific information.

In this embodiment, the small sample is data of characteristic information unique to the own child base partially extracted from inspection data collected in the child servers 200. The characteristic information unique to the own child base is data recognized wrongly in the child base (data that is abnormal only in the child base), data indicating a characteristic matter concerning a production process in the child base, and the like. Specifically, for example, when a noise environment is present in the child base, the feature-value extracting unit 206 extracts, as the small sample, data generated under the noise environment. When a material and a machine different from materials and machines in other bases are used in the child base, the feature-value extracting unit 206 extracts, as the small sample, data indicating a change of the material and a change of the machine.

Note that, concerning the number of extractions of the small sample, a range or the like of the number of extractions may be determined in advance (for example, several hundred), the number of extractions may be changed according to an actual production state, or, when there are extremely many pieces of target data from which the small sample is extracted (for example, several thousand pieces of misrecognized data), the small sample may be extracted from the target data at random.

The feature-value sharing unit 207 has a function of sharing, with the mother server 100, the feature value and the data (the small sample) extracted by the feature-value extracting unit 206.

The model saving unit 222 saves a child model and a verification dataset used in the own child base and a model management table concerning the own child base.

The feature-value-data saving unit 223 saves the feature value and the data (the small sample) extracted by the feature-value extracting unit 206 in the own child base. The feature value and the small sample saved in the feature-value-data saving unit 223 are shared with the mother server 100 by the feature-value sharing unit 207.

### (2) Data

An example of data used in the training model creation system 1 according to this embodiment is explained.

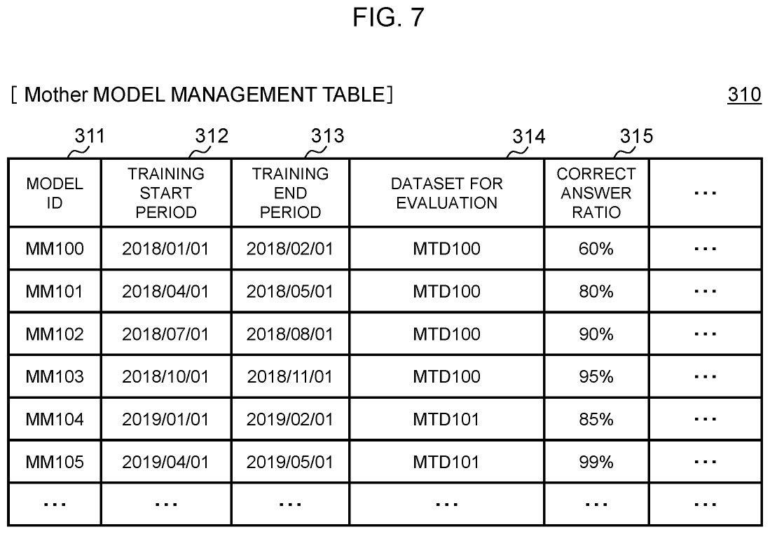

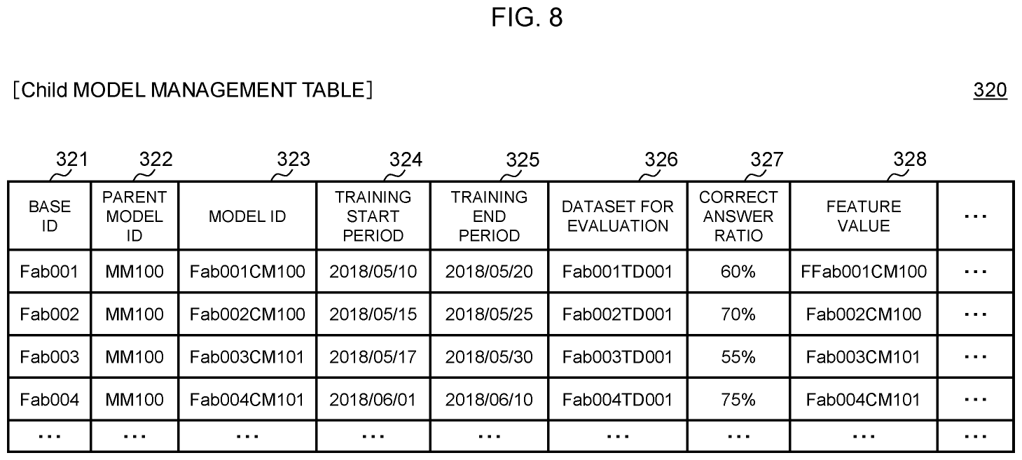

Note that, in this example, a data configuration by a table data format is explained. However, a data format is not limited to this in this embodiment. Any data format can be adopted. Configurations of data are not limited to an illustrated configuration example. For example, in the mother model management table 310 illustrated in FIG. 7 and the child model management table 320 illustrated in FIG. 8, for example, information concerning versions added to models may be further held.

FIG. 7 is a diagram showing an example of the mother model management table. The mother model management table 310 is table data for managing a mother model constructed in the mother server 100 and is saved in the model saving unit 122.

In the case of FIG. 7, the mother model management table 310 is configured from data items such as a model ID 311 indicating an identifier of a target model (a mother model), a training start period 312 indicating a start time of a training period of the target model, a training end period 313 indicating an end time of the training period of the target model, a dataset for evaluation 314 indicating a dataset (a verification dataset) used for evaluation when accuracy verification of the target model is performed, and a correct answer ratio 315 indicating verification accuracy output in the accuracy verification.

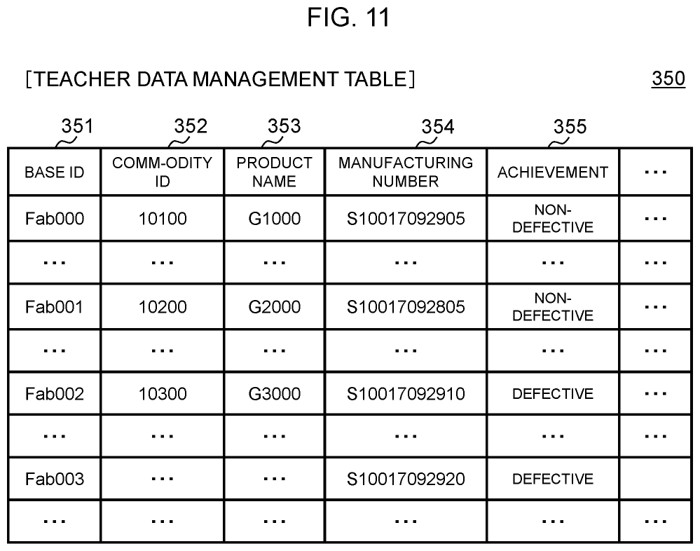

In this example, as shown in the model ID 311 in FIG. 7 and a parent model ID 322 in FIG. 8, an identifier of a mother model is represented by a character string starting with “MM”. On the other hand, as shown in a model ID 323 in FIG. 8, an identifier of a child model is represented by a character string starting with “Fab00n (same as a base ID of a child base) ”. Concerning the base ID, as shown in a base ID 321 in FIG. 8, base IDs of child bases are “Fab001” to “Fab004” and a base ID of a mother base is “Fab000” (see a base ID 351 in FIG. 11).

FIG. 8 is a diagram showing an example of the child model management table. The child model management table 320 is table data for the mother server 100 to manage child models constructed in the child bases (the child servers 200) and is saved in the model saving unit 122.

In the case of FIG. 8, the child model management table 320 is configured from data items such as the base ID 321 indicating an identifier of a child base where a target model (a child model) is constructed, the parent model ID 322 indicating an identifier of a parent model (a mother model) based on which the target model is constructed, the model ID 323 indicating an identifier of the target model, a training start period 324 indicating a start time of a training period of the target model, a training end period 325 indicating an end time of the training period of the target model, a dataset for evaluation 326 indicating a dataset (a verification dataset) used for evaluation when accuracy verification of the target model is performed, a correct answer ratio 327 indicating verification accuracy output in the accuracy verification, and a feature value 328 indicating a feature value extracted from the target model. Actual data of the verification dataset shown in the dataset for evaluation 326 is also saved in the model saving unit 122.

A model management table having the same configuration as the configuration of the child model management table 320 shown in FIG. 8 is saved in the model saving units 222 of the child servers 200 as well. However, in the child servers 200, since it is unnecessary to manage a child model constructed in a base other than the own base, the model saving units 222 only have to save a model management table configured by only records concerning the own child bases among records included in the child model management table 320. The model saving units 222 save child models used in the own child bases and actual data of verification datasets of the child models.

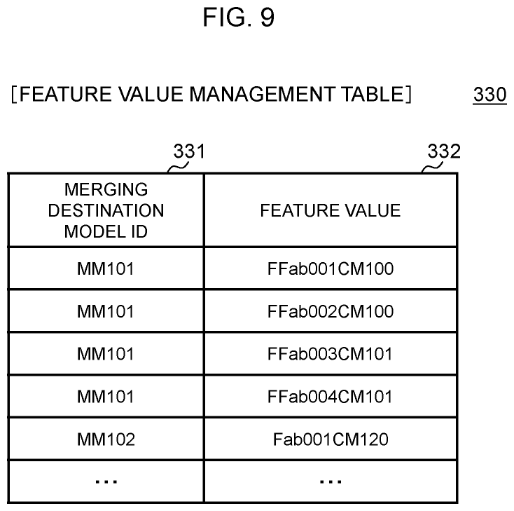

FIG. 9 is a diagram showing an example of the feature value management table. The feature value management table 330 is table data for managing a feature value (a merged feature value) captured when a mother model is reconstructed. The feature value management table 330 is saved in the feature-value-data saving unit 123.

In the case of FIG. 9, the feature value management table 330 holds a combination of a merging destination model ID 331 indicating an identifier of a reconstructed mother model and a feature value 332 used for the reconstruction of the mother model. As explained below in steps S112 to S113 in FIG. 13, the mother server 100 merges feature values shared from the plurality of child servers 200 and captures the merged feature value to reconstruct the mother model.

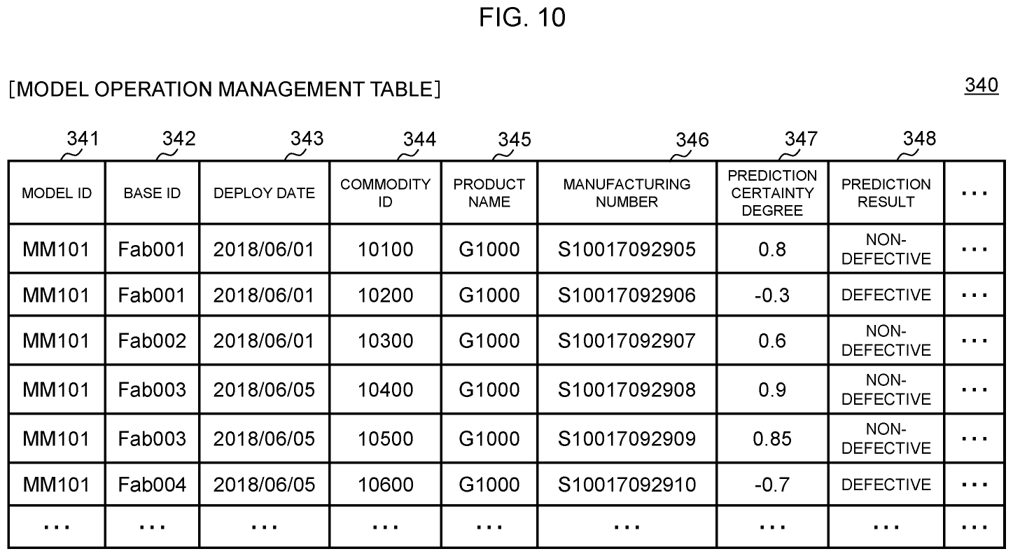

FIG. 10 is a diagram showing an example of the model operation management table. The model operation management table 340 is table data for the mother server 100 to manage information concerning operation and monitoring of a model and is saved in the model saving unit 122.

In the case of FIG. 10, the model operation management table 340 is configured from data items such as a model ID 341, a base ID 342, a deploy date 343, a commodity ID 344, a product name 345, a manufacturing number 346, a prediction certainty degree 347, and a prediction result 348.

An identifier of a target model (an operated model) is shown in the model ID 341. An identifier of a base where the target model is operated is shown in the base ID 342. A date when the target model is applied is shown in the deploy date 343. An identifier (a commodity ID) of a commodity in which a product is incorporated, a product name, and a serial number (a manufacturing number) are recorded in the commodity ID 344, the product name 345, and the manufacturing number 346 as information concerning a target product of a process inspection. A result of abnormality detection for detecting an abnormality of the product using the target model is shown in the prediction result 348. A certainty degree of the result is shown in the prediction certainty degree 347.

Note that a model operation management table configured the same as the model operation management table 340 is saved in the model saving unit 222 of the child server 200 concerning operation and monitoring of a model (a child model) in the own base.

FIG. 11 is a diagram showing an example of the teacher data management table. The teacher data management table 350 is a table data for managing teacher data used for accuracy verification (step S119 in FIG. 13) during model update determination for a mother model by the mother server 100 and is saved in the model saving unit 122.

In the case of FIG. 11, the teacher data management table 350 is configured from data items such as a base ID 351, a commodity ID 352, a product name 353, a manufacturing number 354, and an achievement 355. A value of the base ID 351 corresponds to values of the base ID 321 shown in FIG. 8 and a value of the base ID 342 shown in FIG. 10. Values of the commodity ID 352, the product name 353, and the manufacturing number 354 correspond to values of the commodity ID 344, the product name 345, and the manufacturing number 345 shown in FIG. 10. A value of the achievement 355 corresponds to a value of the prediction result 348 shown in FIG. 10.

Note that, in the teacher data management table 350, not only teacher data, achievement of which is evident in advance, but also data of a small sample extracted in the child server 200 and shared by the mother server 100 can also be managed as teacher data. By using the small sample data as the teacher data as well in this way, the mother server 100 can imposes a highly accurate verification standard to the reconstructed mother model.

### (3) Processing

FIG. 12 is a flowchart mainly showing a processing procedure example by the training model creation system at the time when an initial model is constructed. The flowchart of FIG. 12 is divided into processing on the mother server 100 side and processing on the child server 200 side. The processing on the child server 200 side is executed in each of the plurality of child bases. This is the same in FIG. 13 referred to below. “A” and “B” shown in FIG. 12 correspond to “A” and “B” shown in FIG. 13 referred to below.

In FIG. 12, the processing on the mother server 100 side is started at a timing of a process inspection in a production process in a mother base. The process inspection may be prepared at a plurality of implementation timings in the production process. Like the processing on the mother server 100 side, the processing on the child server 200 side is started at a timing of a process inspection in a production process in an own child base. However, processing in step S203 and subsequent steps is executed after processing in step S108 on the mother server 100 side is performed.

As the processing on the mother server 100 side, first, at the timing of the process inspection in the mother base, the data acquiring unit 102 collects inspection data of a type designated in the process inspection and saves the collected inspection data in the inspection-data saving unit 121 (step S101).

Subsequently, the data preprocessing unit 103 performs predetermined processing on the inspection data collected in step S101 (step S102).

Subsequently, the version managing unit 104 determines, referring to the mother model management table 310 stored in the model saving unit 122, whether an initial model needs to be constructed (step S103). During first processing, since a mother model (Mother model v1.0) serving as an initial model is not constructed, a determination result in this step is YES and the processing proceeds to step S104. On the other hand, when the processing in step S101 is performed again from “A” through processing in FIG. 13 explained below, a mother model serving as an initial model is saved in the model saving unit 122 (that is, management information of the mother model is recorded in the mother model management table 310). Therefore, a determination result in step S103 is NO. In this case, the processing proceeds to after processing in step S108. The processing in FIG. 13 is performed again after a feature value and data are shared from the child server 200 in step S207.

When it is determined “YES” (the initial model needs to be constructed) in step S103, the model training unit 105 constructs a mother model serving as the initial model (step S104), reads, in the constructed mother model (initial model), the inspection data on which the processing is performed in step S102, and actually performs model training (step S105). The model training unit 105 saves the trained mother model (Mother model v1.0) in the model saving unit 122 and registers information concerning the model in the mother model management table 310.

Subsequently, the model verifying unit 106 performs accuracy verification of the trained model (the initial model) saved in the model saving unit 122 in step S105 (step S106). Specifically, the model verifying unit 106 reads the trained model, calculates an inference result (a reasoning result) in the model using a predetermined verification dataset as input data, and outputs verification accuracy of the trained model. At this time, the model verifying unit 106 registers the verification dataset used for the accuracy verification in the dataset for evaluation 314 of the mother model management table 310 and registers the obtained verification accuracy in the correct answer ratio 315.

Subsequently, the model verifying unit 106 determines whether the verification accuracy obtained in step S106 achieves a predetermined accuracy standard for enabling a model to be adopted (step S107). The accuracy standard is determined beforehand. For example, “accuracy 90%” is set as a standard value. In this case, if the verification accuracy obtained in the accuracy verification of the model is 90% or more, the model verifying unit 106 determines that the model may be adopted (YES in step S107) and the processing proceeds to step S108. On the other hand, when the verification accuracy obtained in the accuracy verification of the model is less than 90%, the model verifying unit 106 determines that the model cannot be adopted (NO in step S107) and the processing returns to step S101 and proceeds to processing for retraining the model. Note that, when the model is retrained, in order to improve the verification accuracy of the model, processing contents of steps S101 to S105 may be partially changed. For example, it is possible to increase the inspection data collected in step S101, change the processing carried out in step S102, and change a training method of the model training in step S106.

In step S108, the model sharing unit 107 shares, with the child servers 200 in the child bases, the trained model that achieves the standard instep S107 (that is, the trained model of the mother model constructed as the initial model in step S104). When sharing the initial model, the model sharing unit 107 transmits design information (for example, a network structure and a feature value) of the trained initial model (Mother model v1.0) to the child servers 200. The child servers 200 receive and save the design information of the initial model, whereby the initial model is shared between the mother server 100 and the child servers 200.

Note that, in FIG. 12, on the child server 200 side, at the timing of the process inspection in the own child base, the data acquiring unit 202 collects inspection data and saves the inspection data in the inspection-data saving unit 221 (step S201). The data preprocessing unit 203 performs predetermined processing on the inspection data (step S202). The processing in steps S201 to S202 is the same as the processing in steps S101 to S102 on the mother server 100 side.

On the child server 200 side, after the processing in step S102 ends, the child server 200 stays on standby for the following processing until the processing in step S108 is performed and the initial model is shared on the mother server 100 side.

When the initial model is shared in step S108, in the child server 200, the model training unit 204 constructs a child model based on the design information (for example, the network structure and the feature value) of the initial model received from the mother server 100 (step S203). At this time, for example, the network structure of the child model to be constructed may be the same as the network structure of the initial model (the mother model). However, for improvement of verification accuracy of the child model, it is preferable that tuning corresponding to the child base is performed for hyper parameters (for example, a training rate and the number of times of training). By applying such tuning, although based on the initial model, it is possible to construct a child model taking into account characteristics of the child base.

Subsequently, the model training unit 204 reads, in the child model constructed in step S203, the inspection data on which the processing is performed in step S202, performs model training, and saves a trained model in the model saving unit 222 (step S204). In the training in step S204, specifically, for example, the model training unit 204 performs active training, transfer training, and the like. Concerning the trained child model, the model training unit 204 updates the model management table saved in the model saving unit 222.

Subsequently, the model verifying unit 205 performs accuracy verification of the trained child model saved in the model saving unit 222 in step S204 (step S205). Specifically, the model verifying unit 205 reads the trained model, calculates an inference result (a reasoning result) in the model using a predetermined verification dataset as input data, and outputs verification accuracy of the trained model. At this time, the model verifying unit 205 registers the verification dataset used for the accuracy verification as a dataset for evaluation of the model management table and registers the obtained verification accuracy as a correct answer ratio.

Subsequently, the feature-value extracting unit 206 extracts a feature value of the trained child model (step S20 6). The processing in step S2 0 6 is performed, whereby, as explained in detail in the explanation of the feature-value extracting unit 206, a combination of coefficients of tiers best representing characteristics of the child base is extracted as the feature value. The extracted feature value is saved in the feature-value-data saving unit 223.

In step S206, the feature-value extracting unit 206 extracts, as a small sample, characteristic information of the own child base out of the inspection data collected in the child server 200 (which may be the inspection data acquired by the data acquiring unit 202 but is preferably inspection data after being subjected to the processing in step S202). The extracted data (small sample) is saved in the feature-value-data saving unit 223 together with the feature value.

In this way, the feature value and the small sample extracted by the feature-value extracting unit 206 are the data representing the characteristics in the bases. Even if the initial model (the mother model) on which the child model is based is common, since production processes, manufacturing environments, and the like of the child bases are different, a different feature value and a different small sample are extracted for each of the child bases (the child servers 200).

Subsequently, the feature-value sharing unit 207 shares, with the mother server 100, the feature value and the data (the small sample) extracted in step S206 (step S207).

When sharing the feature value and the data, the feature-value sharing unit 207 transmits the feature value and the data from the child server 200 to the mother server 100. Thereafter, the child server 200 shifts to a standby state until a model is shared from the mother server 100 in step S120 in FIG. 13 explained below.

On the other hand, after sharing the initial model in step S108, the mother server 100 stays on standby until the processing in step S207 is performed and the feature value and the data are shared in the child servers 200. Thereafter, processing in step S111 in FIG. 13 is performed.

A series of processing shown in FIG. 12 is performed as explained above, whereby the initial model trained in the mother base (the mother server 100) is shared by the respective child bases (child servers 200). In the child bases, feature values and small samples reflecting production processes, manufacturing environments, and the like of the child bases are extracted through the training of the child model constructed based on the shared initial model. Further, since the feature values and the small samples of the child bases are shared by the mother base (the mother server 100), sufficient information representing characteristics of the child bases can be fed back to the mother base.

FIG. 13 is a flowchart showing a processing procedure example by the training model creation system after the feature value and the data are shared from the child server.

In FIG. 13, the processing on the mother server 100 side is started at any timing after the sharing of the feature value and the data by the child server 200 are performed in step S207 in FIG. 12. As a specific start timing, for example, the mother server 100 may execute the processing periodically, for example, one in a half year, may execute the processing when the feature value and the data are shared from a predetermined number of (including one or all) child bases (child servers 200), or may execute the processing after waiting for the feature value and the data to be shared from a specific child base (child server 200).

As the processing on the mother server 100 side, first, in response to the processing in step S207 in FIG. 12, the feature-value acquiring unit 108 receives a feature value and data (a small sample) transmitted from the child server 200 and saves the feature value and the data in the feature-value-data saving unit 123 (step S111). The sharing of the feature value and the data from the child server 200 is carried out from the child server 200 of each of a plurality of expanded child bases. In step S111, the feature-value acquiring unit 108 acquires a feature value of the mother model (Mother model v1.0) in the mother server 100 and saves the feature value in the feature-value-data saving unit 123 like the feature value of the child model.

Subsequently, the feature-value merging unit 109 merges the feature values (the feature values of the mother model and the child models) acquired in step S111 (step S112). In the mother base and the child bases, although the initial model is common, feature values trained in the bases are different. In the processing in step S112, these feature values are merged.

Subsequently, the model training unit 105 captures a merged feature value merged in step S112 and reconstructs a mother model (step S113). A method of reconstructing the mother model in step S113 may be the same as the method of constructing the initial model in step S104 in FIG. 12. However, in step S113, in order to capture the merged feature value, for example, after feedback by the merged feature value is applied to a feature value of a partial tier of a network structure of a mother model (Mother model v1.0) in the past, the mother model is reconstructed. Values of hyper parameters of the mother model to be reconstructed may be changed based on the small sample acquired in step S111.

Subsequently, the model training unit 105 reads inspection data in the mother model reconstructed in step S113 and actually performs model training (step S114). The model training unit 105 saves design information of the trained mother model (Mother model v1.1) in the model saving unit 122 and registers management information concerning the model in the mother model management table 310. The model training unit 105 links an identifier (the merging destination model ID 331) of the mother model and the merged feature value (the feature value 332) used for the reconstruction of the mother model and registers the identifier and the merged feature value in the feature value management table 330.

In FIGS. 14 and 15, examples of specific processing images insteps S111 to S114 explained above are shown. FIG. 14 is a diagram for explaining an example of a specific method from the extraction of the feature value to the model retraining. FIG. 15 is a diagram for explaining another example of the specific method.

Specifically, in both the methods shown in FIGS. 14 and 15, first, from intermediate layers of n models (Mother model v1.0, Child1 model v1.0, . . . , and Child (n-1) model v1.0) used inn bases in total (a mother base and child bases), feature values of the models are extracted as vectors (extraction of multidimensional feature vectors). The extracted feature values represent characteristics of the bases such as “small amount production”, “noisy environment”, and “unstable power environment”.

Subsequently, in the method shown in FIG. 14, extracted n m-dimensional feature vectors are converted into an N×M matrix (feature value merging). By retraining the models in a convolutional neural network (CNN), feature values of the bases are fed back. A mother model (Mother model v1.1) can be generated.

On the other hand, in the method shown in FIG. 15, extracted n multidimensional feature vectors are coupled into one vector (feature value merging). By retraining the models with multilayer perceptron (MLP) of several tiers using a merged feature value, feature values of the bases are fed back. A trained mother model (Mother model v1.1) is generated.

Referring back to the explanation of FIG. 13, after the training (the retraining) of the mother model reconstructed in step S114 is performed, the model verifying unit 106 performs accuracy verification of the trained model (Mother model v1.1) saved in the model saving unit 122 in step S114 (step S115). Specifically, the model verifying unit 106 reads the trained model, calculates an inference result (a reasoning result) in the model using a predetermined verification dataset as input data, and outputs verification accuracy of the trained model. At this time, the model verifying unit 106 registers the verification dataset used for the accuracy verification in the dataset for evaluation 314 of the mother model management table 310 and registers the obtained verification accuracy in the correct answer ratio 315.

Subsequently, the model verifying unit 106 determines whether the verification accuracy obtained in step S115 achieves a predetermined accuracy standard for enabling the model to be adopted (step S116). The processing instep S116 is the same as the processing in step S107 in FIG. 12. Detailed explanation of the processing is omitted. When the model verifying unit 106 determines in step S116 that the accuracy standard is achieved (YES in step S116), the processing proceeds to step S117. When the model verifying unit 106 determines that the accuracy standard is not achieved (NO in step S116), the processing returns to step S101 in FIG. 12.

In step S117, the model operation unit 110 applies (deploys) the reconstructed trained model (Mother model v1.1) to the full-scale operation environment of the mother server 100 and starts operation. In other words, the reconstructed trained model is placed on a production process of the mother base according to the deploy in step S117.

After step S117, during the operation of the deployed model, the model operation unit 110 performs reasoning (identification) from input data using the model and performs monitoring on a result of the reasoning (step S118).

At a predetermined timing after the deploy (for example, three months after), the model verifying unit 106 verifies accuracy of the reasoning result by the deployed model and determines whether a predetermined accuracy standard for enabling the model to be operated is satisfied (step S119).

The processing in step S119 is explained in detail. The determination processing in step S119 is processing for evaluating performance of the mother model. For example, when teacher data is held (see the teacher data management table 350), the model verifying unit 106 may calculate accuracy of the reasoning result of the model using the teacher data. When teacher data prepared in advance is absent, the model verifying unit 106 may evaluate performance of the mother model based on information collected from the child bases. In this case, specifically, for example, the model verifying unit 106 periodically extracts a fixed small number of sample data (for example, several hundred) at random from the production process of the childbases, labels a result determined by a site engineer as “True label”, and uses the result as a verification dataset for the mother model. The model verifying unit 106 calculates an inference result (a reasoning result) of the mother model using the verification dataset as input data and compares the reasoning result and the determination result of the site engineer. Consequently, the model verifying unit 106 can calculate accuracy of the reasoning result of the model (a coincidence ratio with the determination result of the site engineer).

The model verifying unit 106 determines whether the accuracy of the reasoning result of the model calculated as explained above satisfies a predetermined accuracy standard (an accuracy standard of model operation) concerning operation continuation of the model. The accuracy standard of the model operation may be determined by a consultation with a site manager or the like in a production base and can be set to a standard value of, for example, “accuracy 90%”. “Accuracy of a reasoning result by a model (Mother model v1.1) of the present version is improved from accuracy of a reasoning result by a model (Mother model v1.0) of the immediately preceding version” may be set as the accuracy standard of the model operation. For example, the two accuracy standard may be combined. When the accuracy of the reasoning result of the model satisfies the accuracy standard of the model operation (YES in step S119), the model verifying unit 106 permits the operation continuation of the model and the processing proceeds to step S120. On the other hand, when the accuracy of the reasoning result of the model does not satisfy the accuracy standard of the model operation (NO in step S119), the model verifying unit 106 denies the operation continuation of the model. The processing returns to step S101 and proceeds to processing for retraining the mother model. When the mother model is retrained, as in the case of NO in step S107 in FIG. 12, in order to improve the verification accuracy of the model, the processing contents in the following steps S101 to S105 may be partially changed.

When the operation continuation of the model is permitted in step S119, the model sharing unit 107 shares, with the child servers 200 in the child bases, the trained model that achieves the standard in step S119, that is, the mother model (Mother model v1.1) being operated in the mother server 100 (step S120). A specific method of the model sharing in step S120 may be the same as the processing in step S108 in FIG. 12. Detailed explanation of the method is omitted.

In response to the model sharing in step S120, in the child server 200 at the sharing destination, the model operation unit 208 applies (deploys) the shared mother model (Mother model v1.1) as a child model used for abnormality detection in the child server 200 and starts operation (step S211). In other words, the trained model distributed from the mother server 100 is expanded to the production process in the child base by the deploy.

After step S211, during the operation of the deployed model, the model operation unit 208 performs reasoning (identification) from input data using the model and performs monitoring on a result of the reasoning (step S212).

At a predetermined timing after the deploy (for example, one month after), the model verifying unit 205 verifies accuracy of the reasoning result by the deployed model and determines whether a predetermined accuracy standard for enabling the model to operate is satisfied (step S213). The determination processing in step S213 is processing for evaluating performance of a child model. For example, when teacher data is held, the model verifying unit 205 may calculate accuracy of the reasoning result of the model using the teacher data. When teacher data prepared in advance is absent, the model verifying unit 205 may evaluate performance of the child model based on information collected from the own child bases. In this case, specifically, for example, the model verifying unit 205 can extract a fixed small number of sample data (for example, several hundred) at random from the own child base, label a result determined by a site engineer as “True label”, and calculate accuracy of the reasoning result of the model (a coincidence ratio with the determination result of the site engineer) based on the “True label”. The model verifying unit 205 determines whether the accuracy of the reasoning result of the model calculated as explained above achieves a predetermined standard value (which may be determined in consultation with a site manager or the like of a production base; for example, “accuracy 90%”).

When the accuracy of the reasoning result by the deployed model is equal to or higher than the predetermined standard value in step S213 (YES in step S213), the operation continuation of the model is permitted. As a result, in both of the mother server 100 and the child server 200, the predetermined accuracy standard is achieved concerning the same model (Mother model v1.1) and it is determined that the operation can be continued. Therefore, in a plurality of bases where the mother server 100 or the child servers 200 are disposed, the training model creation system 1 can apply a robust common model having accuracy for enabling the common model to operate in the bases to a model of a neural network used to perform abnormality detection in the bases.

On the other hand, when the accuracy of the reasoning result by the deployed model is lower than the predetermined standard value in step S213 (No in step S213), the operation continuation of the model is denied. In this case, the processing returns to step S201 in FIG. 12 and proceeds to processing for recollecting inspection data in the child base. After the processing returns to step S201, new inspection data is acquired, a feature value and a small sample are extracted again (step S206), the feature value and the small sample are shared with the mother server 100 (step S207). Consequently, the processing in step S112 and subsequent steps is performed in the mother server 100. A model can be reconstructed and retrained. In the training model creation system 1, when the accuracy standard concerning the operation continuation of the child model cannot be achieve in step S213, the processing is repeated. Consequently, characteristics in the child base can be repeatedly fed back to the mother base (the mother server 100). Therefore, finally, construction of a robust common model adapted to the bases can be expected.

Note that, although not shown in FIG. 13, irrespective of which determination result is obtained in step S213, it is preferable that the determination result is notified from the child server 200 to the mother server 100. When such a determination result is notified, the mother server 100 can recognize early whether expansion of the common model (Mother model v1.1) is successful. If various management tables and the like are updated based on the notification, the mother server 100 can perform model management with the latest information. When the accuracy standard cannot be achieved in step S213, for example, if an alert is generated, it is notified that appropriate model operation is not performed in the child base. Therefore, according to necessity, it is possible to support measures for, for example, immediately recollecting inspection data and requesting reconstruction of a mother model.

Summarizing a series of processing in FIGS. 12 and 13 explained above, the training model creation system 1 according to this embodiment performs the following processing. First, the trained model constructed and trained in the mother base (the mother server 100) is shared with the child bases as the initial model (step S108 in FIG. 12). In the child bases (the child servers 200), the information (the feature values and the small samples) due to the characteristics of the own bases are extracted through the construction and the training of the child models based on the common initial model (step S206 in FIG. 12) and shared with the mother base (step S207 in FIG. 12). In the mother base, the mother model is reconstructed and trained using the feature value obtained by merging the feature values of the bases including the mother base. Consequently, it is possible to generate the trained model to which the characteristics of the mother base and the child bases are fed back (steps S110 to S114 in FIG. 13). Further, in the mother base, when the trained model of the reconstructed mother model satisfies the accuracy standard for enabling the trained model of the reconstructed mother model to operate, the trained model can be applied to not only the own bases but also the full-scale operation environment (the production process) of the child bases as the common model. As a result, in the training model creation system 1, the characteristic information obtained in the bases can be deployed (the training model can be shared) in the neural network for diagnosing the state of the inspection target so that the bases can cooperate with one another early. The training model creation system 1 can construct, early, a robust common model that can withstand surrounding environments and machining conditions in the bases.

The training model creation system 1 according to this embodiment collects various kinds of information (feature values and small samples) targeting a global plurality of child bases in which various environments, materials, and the like are expanded and reflects the information on the common model. Consequently, the information can be reflected on a common model having higher accuracy.

The training model creation system 1 according to this embodiment applies the common model to the mother base (the mother server 100) and the plurality of child bases (child servers 200). Therefore, a training result can be shared among the plurality of child bases. That is, an event (an abnormality) that occurs in other bases and can occur in the own base in future can be trained beforehand. Therefore, it can be expected that failure factors in the bases are grasped early.

In the related art, when states of the child bases are notified to the mother base, unless all inspection data collected in the child bases are transmitted, it is highly likely that accuracy is insufficient. However, in the training model creation system 1 according to this embodiment, as explained in steps S206 to S207 in FIG. 12, the feature value is passed to the mother server 100 together with a part (the small sample) of the inspection data. Therefore, sufficient information concerning the child bases (the child servers 200) can be transmitted to the mother base (the mother server 100) with a relatively small data amount. Therefore, an effect of reducing a communication load and a processing load can be expected.

In the processing shown in FIG. 13, a processing progress for applying the mother model, which is reconstructed based on the feature values and the data (the small samples) collected from the plurality of child servers 200, in the mother server 100 first and performing the model monitoring and, when the accuracy of the reasoning result of the mother model satisfies the standard for operation continuation, sharing the mother model with the child servers 200 is adopted. Therefore, the common model can be expanded to the child bases after safety of the model in the full-scale operation environment of the mother base is confirmed. Therefore, an effect of suppressing un-achievement of the standard of the operation continuation in the child bases can be expected. However, the sharing method for the training model in this embodiment is not limited to the processing procedure shown in FIG. 13. For example, as another processing progress, before the standard achievement of the operation continuation is confirmed on the mother server 100 side, the reconstructed mother model may be shared with the child servers 200. The child server 200 side may perform the model monitoring by applying the model and determine whether accuracy of a reasoning result of the model satisfies the standard of the operation continuation. As a specific flow of the processing, when it is determined YES in step S116, the processing shifts to step S120. The processing in steps S211 to S213 is performed on the child server 200 side. After the processing in step S213 ends in the child server 200, the processing in steps S117 to S119 of the mother server 100 only has to be performed. In this case, confirmation of safety in the mother base is delayed till later. However, it is possible to obtain an effect that the common model can be expanded to the child bases earlier.

Note that the present invention is not limited to the embodiment explained above. Various modifications are included in the present invention. For example, the embodiment is explained in detail in order to clearly explain the present invention. The embodiment is not always limited to an embodiment including all the component explained above. Concerning a part of the components in the embodiment, addition, deletion, and replacement of other components can be performed.

A part or all of the components, the functions, the processing units, the processing means, and the like explained above may be realized by hardware by, for example, designing the components, the functions, the processing units, the processing means, and the like as integrated circuits. The components, the functions, and the like may be realized by software by a processor interpreting and executing programs for realizing the respective functions. Information such as programs, tables, and files for realizing the functions can be put in a recording apparatus such as a memory, a hard disk or an SSD (Solid State Drive) or a recording medium such as an IC card, an SD card, or a DVD.

In the drawings, control lines and information lines considered necessary in explanation are shown. Not all of the control lines and the information lines are shown in terms of a product. Actually, it may be considered that almost all the components are connected to one another.

What is claimed is:

1. A training model creation system that inspects, with a neural network, a process carried out in a plurality of bases including a first base and a plurality of second bases,
the training model creation system comprising:
a first server that diagnoses a state of an inspection target in the first base using a first model of the neural network; and
a plurality of second servers that diagnose a state of an inspection target in each base of the plurality of second bases using a second model of the neural network, wherein
the first server receives feature values of the trained second model from the respective plurality of second servers, merges a received plurality of feature values of the second model and a feature value of the trained first model, and reconstructs and trains the first model based on a merged feature value.

2. The training model creation system according to claim 1, wherein the feature values of the first and the second models are represented by, in a tier structure of the models, combinations of weights of tiers representing characteristics of bases or processes in which the models are operated.

3. The training model creation system according to claim 1, wherein
after constructing and training an initial model, the first server shares the trained initial model with the plurality of second servers, and
after capturing characteristics of the own bases and constructing and training the second model based on the initial model shared from the first server, the second servers extract the feature values from the trained second model and transmit the feature values to the first server.

4. The training model creation system according to claim 1, wherein
the first server shares, with the plurality of second servers, a third model, which is a trained model of the reconstructed first model, and
the first server and the plurality of second servers apply the common third model to the neural network for diagnosing an inspection target of the own bases.

5. The training model creation system according to claim 4, wherein
the first server applies the third model to the neural network for diagnosing an inspection target of the first base and, when accuracy of a reasoning result by the third model after the application satisfies a predetermined accuracy standard, shares the third model with the plurality of second servers, and
the second servers apply the third model to the neural network for diagnosing an inspection target of the second bases.

6. The training model creation system according to claim 4, wherein
the first server shares the third model with the plurality of second servers,
the second servers apply the third model to the neural network for diagnosing an inspection target of the second bases, and
when accuracy of a reasoning result by the third model after the application satisfies a predetermined accuracy standard in the second servers, the first server applies the third model to the neural network for diagnosing an inspection target of the first base.

7. The training model creation system according to claim 3, wherein
the second servers transmit sample data obtained by extracting characteristic information of the own bases from inspection data collected in the own bases to the first server together with the feature values extracted from the trained second model, and
the first server reconstructs and trains the first model based on the received sample data and a feature value obtained by merging the received plurality of feature values and the feature value of the trained first model.

8. The training model creation system according to claim 1, wherein respective factories or respective lines provided in the factories are units of the first base and the plurality of second bases.

9. A training model creation method by a system that inspects, with a neural network, a process carried out in a plurality of bases including a first base and a plurality of second bases,
the system including:
a first server that diagnoses a state of an inspection target in the first base using a first model of the neural network; and
a plurality of second servers that diagnose a state of an inspection target in each base of the plurality of second bases using a second model of the neural network,
the training model creation method comprising:
a feature value receiving step in which the first server receives feature values of the trained second model from the respective plurality of second servers;
a feature value merging step in which the first server merges a plurality of feature values of the second model received in the feature value receiving step and a feature value of the trained first model; and
a common model creating step in which the first server reconstructs and trains the first model based on the feature value merged in the feature value merging step.

10. The training model creating method according to claim 9, wherein the feature values of the first and the second models are represented by, in a tier structure of the models, combinations of weights of tiers representing characteristics of bases or processes in which the models are operated.

11. The training model creating method according to claim 9, further comprising, before the feature value receiving step;
an initial model sharing step in which, after constructing and training an initial model, the first server shares the trained initial model with the plurality of second servers; and
a feature value transmitting step in which, after capturing characteristics of the own bases and constructing and training the second model based on the initial model shared in the initial model sharing step, the second servers extract the feature values from the trained second model and transmit the feature values to the first server.

12. The training model creating method according to claim 9, further comprising, after the common model creating step:
a common model sharing step in which the first server shares, with the plurality of second servers, a third model, which is a trained model of the first model reconstructed in the common model creating step; and
a common model operation step in which the first server and the plurality of second servers apply the common third model to the neural network for diagnosing an inspection target of the own bases.

13. The training model creating method according to claim 11, wherein
in the feature value transmitting step, the second servers transmit sample data obtained by extracting characteristic information of the own bases from inspection data collected in the own bases to the first server together with the feature values extracted from the trained second model, and
in the common model creating step, the first server reconstructs and trains the first model based on the received sample data and a feature value merged in the feature value merging step.
